(19) United States
(12) Patent Application Publication
(10) Pub. No.: US 2008/0247931 A1
(43) Pub. Date: Oct. 9, 2008

(54) Method for Producing Multi-Constituent, Metal Oxide Compounds Containing Alkali Metals,and thus Produced Metal Oxide Compounds

(75) Inventors: Rainer Domesle, Alzenau-Kaelberau (DE); Stefan Ambrousius, Berlstedt (DE); Thomas Kreuzer, Karben (DE)

Correspondence Address: KALOW & SPRINGUT LLP, 488 MADISON AVENUE, 19TH FLOOR, NEW YORK, NY, 10022, US

(73) Assignee: UMICORE AG & CO. KG, Hanau-Wolfgang (DE)

(21) Appl. No.: 11/662,125

(22) PCT Filed: Sep. 10, 2005
(86) PCT No.: PCT/EP2005/009759

§ 371 Date: Feb. 4, 2008

(30) Foreign Application Priority Data
Sep. 10, 2004 (DE) 10 2004 044 266.5

(51) Int. Cl. C01F 17/00; C01F 7/04; C01G 45/02; C01G 51/04; C01G 25/02; C01G 49/02; C01G 37/02; C01G 53/04; C01G 9/02

(52) U.S. Cl. 423/263; 423/594.15; 423/600; 423/599; 423/594.6; 423/594.12; 423/594.2; 423/596; 423/594.4; 423/594.14

(57) ABSTRACT

The preparation of finely divided, alkali metal-containing metal oxide powders which contain at least one alkali metal and at least one further metal from the group consisting of the transition metals, the remaining main group metals, the lanthanides and actinides is described. Precursor compounds of these components are introduced in solid form or in the form of a solution or a suspension into a pulsation reactor having a gas flow resulting from a flameless combustion and partly or completely converted into the desired multicomponent metal oxide powder.

The present invention relates to a process for preparing alkali metal-containing, multicomponent metal oxide compounds in powder form.

Multicomponent metal oxide compounds are used, for example, in chemistry as catalysts for the preparation of alcohols. Examples of such compounds are given in the U.S. patents U.S. Pat. No. 4,291,126 and U.S. Pat. No. 4,659,742. In addition, such metal oxide compounds are employed in the ceramics industry and in the manufacture of electric batteries, for example the compounds LiAlO₂, LiMn₂O₄, LiCoO₂ or Li₂ZrO₃. It is also known that such metal oxide compounds can additionally be doped, as in the case of, for example, the doped metal oxide compounds La_{0.85}Na_{0.15}MnO₃, LiCu_{0.8}Ni_{0.2}O₂, LiAl_{y}Co_{1-y}O₂ and LiCo_{y}Mn_{2-y}O₄, to improve the use properties. Here, particularly homogeneous doping of the finished metal oxide powders is desired.

Owing to the high solubility of alkali metal compounds, customary precipitation processes from aqueous solutions are virtually ruled out for the preparation of alkali metal-containing powders, particularly when three-component and multicomponent metal oxides are desired.

Customary solid-state reaction processes in rotary tube furnaces or box furnaces lead to rather caked, coarse material which is difficult to break up, since the processes are carried out close to or above the respective melting point. At lower temperatures where there is no risk of caking, the solid-state reactions would proceed only very slowly and would therefore not be economically feasible. In addition, homogeneously doped materials are very difficult to obtain using these customary, thermal processes.

However, owing to, for example, the miniaturization of components, further processing to the end product often requires pulverulent and/or high-surface-area metal oxide compounds having small mean particle diameters, which can be obtained from caked material or material which are sintered together only by means of intensive milling. In this case, the material can be contaminated by abraded materials from milling media.

WO 02/072471 A2 discloses a process for preparing a multinary metal oxide powder which is suitable for use as precursor of high-temperature superconductors. To prepare this powder, a mixture of the corresponding metal salts and/or metal oxides and/or metals containing at least three elements selected from among Cu, Bi, Pb, Y, Tl, Hg, La, in solid form or in the form of a solution or a suspension in the required stoichiometric ratio is introduced into a pulsation reactor having a pulsating gas flow resulting from flameless combustion and partly or completely converted into the multinary metal oxide.

It is an object of the present invention to provide a process for preparing alkali metal-containing, i.e. lithium-, sodium-, potassium-, rubidium- and/or caesium-containing, metal oxide compounds which are in powder form and have a homogeneous distribution of the participating components.

This object is achieved by precursor compounds of the components of the desired metal oxide compound being introduced in solid form or in the form of a solution or a suspension into a pulsation reactor having a gas flow resulting from a flameless combustion and partly or completely converted into the desired metal oxide compound, with the precursor compounds comprising a mixture of at least one first metal compound from the group of the alkali metals with at least one second metal compound selected from the group consisting of the transition metals, the remaining main group metals, the lanthanides and the actinides in the desired ratio. For the purposes of the present invention, alkali metal-containing metal oxide compounds are compounds which consist of at least two components and in which at least one of the compound-forming components is an alkali metal. Examples are LiAlO₂ or LiMn₂O₄. They also include compounds in which an alkali metal and/or metal is partly replaced by another metal, as in, for example, LiCu_{0.8}Ni_{0.2}O₂. Alkali metal-doped compounds (for example La_{0.85}Na_{0.15}MnO₃) in which an alkali metal ion is incorporated into the host lattice are likewise encompassed. Furthermore, the term metal oxide compounds also encompasses materials in which two or more different compounds can be detected by suitable methods, for example by X-ray analysis.

The metal oxide compound is separated from the hot gas stream by means of suitable filters and is then present in powder form having mean particle sizes of up to 125 μm, preferably having mean particle sizes in the range from 0.1 to 50 μm or from 1 to 30 μm. However, nanopowders having mean particle sizes in the range from 10 to 100 nm can also be obtained by this process when the process parameters are selected appropriately and the precursor compounds are introduced in the form of solutions into the pulsating gas stream.

A particular advantage of the process of the invention compared to rotary tube furnaces and tunnel kilns is the extreme uniformity of the thermal treatment in the pulsating gas stream. This is also not ensured in alternative processes such as down pipe treatment with external heating (hot wall reactor), which lead to an inhomogeneous material as a result of different falling speeds and marginal zone effects. Spray pyrolysis and flame pyrolysis processes suffered from similar problems.

On the other hand, calcination in a pulsating gas stream makes it possible to achieve very uniform treatment of the starting materials up to just below the softening or melting points of the starting materials or of the end product without relatively large, caked agglomerates being formed.

The process makes it possible to prepare metal oxide compounds containing lithium, sodium, potassium, rubidium, caesium or mixtures thereof as alkali metals. The second metal compounds are preferably selected from among compounds of aluminium, manganese, cobalt, zirconium, iron, chromium, zinc, nickel and compounds of the lanthanides.

Both the alkali metals and the metals from the group consisting of the transition metals, the remaining main groups metals, the lanthanides and actinides are introduced into the process in the form of a mixture of suitable precursor compounds. Preference is given to introducing aqueous or nonaqueous solutions or suspensions of undissolved and, if appropriate, dissolved precursor compounds into the pulsation reactor. The precursor compounds can be any salts of inorganic or organic acids or inorganic or organic compounds of the metals mentioned, in particular nitrates, chlorides, sulphates, acetates, amines, hydroxides, carbonates, oxalates, citrates and tartrates. The aqueous or nonaqueous solutions of the precursor compounds can additionally contain solid components in the form of hydroxides, oxides, carbonates, oxalates and/or other undissolved salts of the first and second metal compounds.

It is likewise possible to introduce particularly reactive starting materials or material compositions into the reactor as powder mixtures, for example via a powder injector. These powder mixtures can be intimate mixtures of solids in the form of finely divided hydroxides, oxides, carbonates, oxalates and/or undissolved salts of the first and second metal compounds.

A pulsation reactor suitable for use in the process of the invention is described, for example, in WO 02/072471 A2. It comprises a combustion chamber and a resonance tube. Combustion air and fuel are fed into the combustion chamber via aerodynamic valves which open when the pressure in the combustion chamber is lower than outside and close when the pressure is higher. Ignition of the fuel gas mixture in the combustion chamber generates an increased pressure which leads to closure of the aerodynamic valves, as a result of which a pressure wave travels outward in the direction of the resonance tube. The gas flowing out into the resonance tube leads to a reduction in the pressure in the combustion chamber and thus to reopening of the valves. This produces a self-regulating oscillation whose pulsation frequency depends on the reactor geometry and the combustion temperature and can easily be adjusted by a person skilled in the art. Preference is given to setting a pulsation frequency in the range from 10 to 130 Hz.

The temperature of the hot combustion offgases can be set to a value in the range from about 650 to 1400° C. Preference is given to selecting a temperature of the combustion offgases in the range from 700 to 1050° C.

The resonance tube of the pulsation reactor can be interrupted by an expansion chamber in front of which a secondary gas can be introduced to cool the combustion offgases. The temperature of the hot combustion offgases in the resonance tube and expansion chamber can be set to values in the range from 300 to 800° C. by this means. In this way, it is also possible to realize low temperatures below 650° C. in the resonance tube, which cannot be achieved when using a conventional pulsation reactor.

The precursor compounds can be introduced directly into the combustion chamber of the pulsation reactor, into the resonance tube or into the expansion chamber. The choice of the point of introduction into the pulsation reactor depends on the specific properties of the metal oxide compounds which are to be achieved. The treatment time and the temperature in the reaction to the end product can be altered by choice of the point of introduction. Particular properties such as specific surface area or completeness of conversion of the precursor material (e.g. the acid solubility) can be influenced in this way. The reaction temperature in combination with the treatment time determines, for example, the formation of the crystal modification of the end product. In cases where the end product still contains traces of undesirable oxides, experience has shown that these can be eliminated by appropriate optimization of the process parameters. Suitable process parameters for these optimizations are, for example, the concentration of the dissolved precursor compounds, the precursor compounds themselves, the temperature of the hot gas stream and the residence times in the pulsation reactor.

A further advantage compared to other processes which use carbon-containing fuels is that hydrogen can be used as sole fuel or in admixture with other fuels. This prevents formation of the carbonates, which in the case of alkali metals are very stable, i.e. still stable up to very high temperatures, from the carbon-containing fuel gases, so that the solid-state reactions can proceed at an accelerated rate.

To achieve particular properties (reduction in nitrate and chloride contents, modifications, surface area, crystal healing, crystallite size), it may be necessary to subject the metal oxide powder obtained in the pulsation reactor to a further treatment. Here, a further passage through the pulsation reactor or a multistage pulsation reactor can be provided. Of course, customary thermal processes such as treatment in a furnace or in a fluidized-bed reactor are also possibilities. However, the critical step for production of the metal oxide compound is the first treatment step. The subsequent steps are merely modifications to optimize the use properties.

It is likewise possible to provide, for example, an extraction or washing-out of soluble components in place of the thermal treatment described in order to optimize the use properties.

The process makes it possible to prepare, for example, metal oxide compounds in the case of which a precursor compound of lithium is completely or partly reacted with compounds of aluminium, manganese, cobalt or zirconium to form the compounds LiAlO₂, LiMn₂O₄, LiCoO₂ or Li₂ZrO₃. Furthermore, doped compounds such as La_{0.85}Na_{0.15}MnO₃, LiCu_{0.8}Ni_{0.2}O₂, LiAl_{y}Co_{1-y}O₂ and LiCo_{y}Mn_{2-y}O₄ can be entirely or partly obtained by means of the process.

The invention is illustrated by the following examples.

### EXAMPLE 1

### Preparation of the Doped Compound La_{0.8}Na_{0.15}MnO₃

An alkali metal-containing metal oxide powder having the composition La_{0.85}Na_{0.15}MnO₃ was prepared. For this purpose, an aqueous solution of lanthanum nitrate, sodium nitrate and manganese(II) nitrate.4 H₂O having the appropriate stoichiometric ratio and a total oxide concentration of 10% by weight (calculated as La₂O₃, Na₂O and MnO₂) was reacted in a pulsation reactor. The aqueous solution was introduced at a rate of 5.3 kg/h by means of a two-fluid nozzle into the combustion chamber at a temperature of 800° C. The fuel gas flow was 2.8 kg of natural gas/h and the combustion air flow was 66 kg/h. The product was separated off from the hot gas stream by means of ceramic candle filters.

The blackish grey powder formed had a specific surface area (BET) of 15 m²/g, a mean particle size d₅₀ (CILAS 920) of 14 μm and a loss on ignition of 1.9%. X-ray diffraction analysis displayed only the signals of lanthanum manganese oxide LaMnO₃ and thus demonstrates the formation of the doped compound La_{0.85}Na_{0.15}MnO₃. Chemical analysis confirmed this conclusion. The values found corresponded within the limits of analytic accuracy to the expected composition, viz. 52.6% by weight of lanthanum (theoretical: 53.0% by weight), 24.5% by weight of manganese (theoretical: 24.7% by weight) and 1.54% by weight of sodium (theoretical: 1.55% by weight).

### EXAMPLE 2

### Preparation of the Compound LiMn₂O₄

The alkali metal-containing compound LiMn₂O₄ was prepared. For this purpose, an aqueous solution of lithium nitrate and manganese(II) nitrate.4H₂O having the appropriate stoichiometric ratio and a total oxide concentration of 10% by weight (calculated as Li₂O and MnO₂) was reacted in a pulsation reactor. The aqueous solution was introduced at a rate of 5.3 kg/h by means of a two-fluid nozzle into the combustion chamber at 805° C. The fuel gas flow was 2.9 kg of natural gas/h and the combustion air flow was 66 kg/h. The product was separated off from the hot gas stream by means of ceramic candle filters.

The blackish grey powder formed had a mean particle size d₅₀ (CILAS 920) of 3.2 μm and a loss on ignition of 1.9%. Transmission electron micrographs displayed agglomerates having a primary particle size of about 60 nm. X-ray diffraction analysis displayed the signals of lithium manganese oxide LiMn₂O₄ together with traces of Mn₂O₃ and thus demonstrated the formation of the desired compound.

### EXAMPLE 3

### Preparation of the Compound LiCoO₂

The alkali metal-containing compound LiCoO₂ was prepared. For this purpose, an aqueous solution of lithium nitrate and cobalt nitrate.6H₂O having the appropriate stoichiometric ratio and a total oxide concentration of 10% by weight (calculated as Li₂O and CoO) was reacted in a pulsation reactor. The aqueous solution was introduced at a rate of 5.3 kg/h by means of a two-fluid nozzle into the combustion chamber at 710° C. The fuel gas flow was 2.9 kg of natural gas/h and the combustion air flow was 66 kg/h. The product was separated off from the hot gas stream by means of ceramic candle filters.

The blackish grey powder formed had a specific surface area (BET) of 18 m²/h and a mean particle size d₅₀ (CILAS) of 16 μm. X-ray diffraction analysis displayed the signals of lithium cobalt oxide LiCoO₂ together with traces of Co₃O₄ and thus demonstrated the formation of the desired compound.

1. Process for preparing a multicomponent metal oxide compound in powder form, characterized in that precursor compounds of the components of the desired metal oxide compound are introduced in solid form or in the form of a solution or a suspension into a pulsation reactor having a gas flow resulting from a flameless combustion and partly or completely converted into the desired metal oxide compound, with the precursor compounds comprising a mixture of at least one first metal compound from the group of the alkali metals with at least one second metal compound selected from the group consisting of the transition metals, the remaining main group metals, the lanthanides and the actinides in the desired ratio.

2. Process according to claim 1, characterized in that the first metal compounds are selected from among compounds of lithium, sodium, potassium, rubidium and caesium and the second metal compounds are selected from among compounds of aluminum, manganese, cobalt, zirconium, iron, chromium, zinc, nickel and compounds of the lanthanides.

3. Process according to claim 1, characterized in that the precursor compounds of the first and second metal compounds are salts of inorganic or organic acids or inorganic or organic compounds and are introduced as aqueous or nonaqueous solutions into the pulsation reactor.

4. Process according to claim 3, characterized in that the precursor compounds of the first and second metal compounds are in the form of nitrates, chlorides, sulphates, acetates, amines, hydroxides, carbonates, oxalates, citrates and tartrates.

5. Process according to claim 4, characterized in that the aqueous or nonaqueous solutions of the precursor compounds additionally contain solid components in the form of hydroxides, oxides, carbonates, oxalates and/or other undissolved salts of the first and second metal compounds.

6. Process according to claim 1, characterized in that an intimate mixture of solids in the form of finely divided hydroxides, oxides, inorganic or organic salts of the first and second metal compounds are introduced into the pulsation reactor.

7. Process according to claim 1, characterized in that the pulsation reactor comprises a combustion chamber, a resonance tube and, if desired, an expansion chamber in the resonance tube and hot combustion offgases are produced in the combustion chamber by combustion of a fuel and subsequently flow through the resonance tube and, if present, the expansion chamber and the precursor compounds are introduced directly into the combustion chamber of the pulsation reactor, into the resonance tube or into the expansion chamber.

8. Process according to claim 7, characterized in that the gas flow of the pulsation reactor pulsates at 10-130 Hz.

9. Process according to claim 8, characterized in that the temperature of the hot combustion offgases is in the range from 650 to 1400° C.

10. Process according to claim 9, characterized in that the temperature of the hot combustion offgases is in the range from 700 to 1050° C.

11. Process according to claim 10, characterized in that a secondary gas is mixed into the hot combustion offgases between the combustion chamber and the expansion chamber to cool the combustion offgases to a temperature in the range from 300 to 800° C.

12. Process according to claim 7, characterized in that the fuel for the pulsation reactor consists of or comprises hydrogen.

13. Process according to claim 12, characterized in that lithium is used as metal of the first metal compounds and is reacted completely or partly with the metals of the second metal compounds selected from among aluminum, manganese, cobalt and zirconium to form the compounds LiAlO₂, LiMn₂O₄, LiCoO₂ or Li₂ZrO₃.

14. Process according to claim 1, characterized in that doped compounds are entirely or partly obtained.

15. Process according to claim 14, characterized in that doped compounds such as La_{0.85}Na_{0.15}MnO₃, LiCo_{0.8}Ni_{0.2}O₂, LiAl_{y}Co_{1-y}O₂ and LiCo_{y}Mn_{2-y}O₄ are entirely or partly obtained.

16. Process according to claim 1, characterized in that the metal oxide compound obtained is subjected to at least one further treatment in a pulsation reactor.

17. Process according to claim 1, characterized in that the metal oxide compound obtained is subjected to a further treatment in a furnace or fluidized-bed reactor.

18. Process according to claim 1, characterized in that soluble constituents present in the metal oxide compound prepared are removed by washing out or extraction.

19. Metal oxide compound in powder form prepared according to claim 1.
